(19) United States
(12) Patent Application Publication
(10) Pub. No.: US 2006/0274087 A1
(43) Pub. Date: Dec. 7, 2006

(54) Method of presenting images on the screen of a display provided in a wireless terminal and wireless terminal implementing the same

(75) Inventors: Hwan Kim, Gumi-si (KR); Chae-Whan Lim, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung ELectronics Co., Ltd.

(21) Appl. No.: 11/410,893

(22) Filed: Apr. 26, 2006

(30) Foreign Application Priority Data
Jun. 7, 2005 (KR) 2005-48284

(51) Int. Cl. G09G 5/00

(52) U.S. Cl. 345/649

(57) ABSTRACT

A method and wireless terminal for presenting characters or images on a screen of a display provided in a folder pivotally mounted on the main body of a wireless terminal are provided. The method involves detecting an existence of a rotation allowable zone on the screen of the display upon turning the folder relative to the main body, detecting the existence of a pop-up window in the rotation allowable zone, if the rotation allowable zone exists, detecting the existence of particular keys provided in the folder, if the pop-up window exists in the rotation allowable zone, and turning the data presented in the rotation allowable zone and the data in the pop-up window, as well as rearranging the functions of the particular keys, to match the rotational direction of the folder, if the particular keys exist.

### PRIORITY

This application claims the benefit under 35 U.S.C. § 119(a) of a Korean Patent Application filed with the Korean Intellectual Property Office on Jun. 7, 2005 and assigned Serial No. 2005-48284, the entire disclosure is hereby incorporated by reference.

### BACKGROUND OF THE INVENTION

1. Field of the Invention

The present invention relates to a method of presenting characters or images on a screen of a display provided in a wireless terminal that comprises a main body, a folder pivotally mounted on the main body to be turned to at least one of a first lengthwise position at which the folder is disposed parallel with the main body and a second crosswise position at which the folder is disposed crosswise to the main body, and the display mounted on the folder. More particularly, the present invention relates to a method and wireless terminal for properly presenting characters or images on the screen of the display to match the rotational position of the folder upon turning the folder to the second crosswise position.

2. Description of the Related Art

Presently, wireless mobile phones are developed to have a structure that enables high-speed data transmission in addition to conventional voice communication. Namely, the mobile communications network according to IMT 2000 specifications may facilitate high-speed data communication in addition to voice communication with the wireless mobile terminal. The data transmitted through the wireless terminal in data communication may include packet data and video data. The wireless terminal has been also provided with a camera and TV receiver to add a video displaying function, so that the terminal may display or transmit moving or still pictures taken by the camera, and display received TV signals.

In such a conventional wireless terminal, the images are presented in a fixed orientation in reference to the screen of the display, regardless of turning the folder to a second crosswise position. When turning the folder to the second crosswise position, the direction of moving the user's sight line upon reading the screen of the display does not agree with the sight line of the images presented on the screen.

In order to resolve such problem, a method has been proposed to turn all the data presented on the screen of the display to match the rotational position of the folder. More specifically, if a sensor detects the second crosswise position of the folder of the wireless terminal, the control unit controls all data presented on the screen to be properly turned to match the moving direction of the user's sight line. For example, if assuming that the screen consist of a first display zone presenting icon display data, a second display zone presenting characters or images, and a third display zone presenting soft key display data, all data presented in the first, second and third display zones are turned to match the rotational position of the folder.

However, such conventional method suffers a drawback when the turning of all image data presented on the screen requires a considerable increase amount of software data for processing the UI image data, thus consuming much of the wireless terminal's resources. Separate software is required for embodying the crosswise UI for properly presenting the images on the screen turned crosswise in addition to the software for embodying the lengthwise UI. Thus, for both lengthwise and crosswise position of the folder, two UI screens should be designed, which significantly increases the time taken for programming the software.

Additionally, bit maps and text for the crosswise UI must be separately prepared apart from the bit maps and text for the lengthwise UI, which doubles the consumption of the necessary resources such as memory. Furthermore, the color Liquid Crystal Display (LCD), which has recently popularized, and various animation data greatly increase the amount of the bit maps required for displaying the images, thereby resulting in increased production cost.

Accordingly, there is a need for an improved method for presenting images on a display screen of a wireless terminal turned in a crosswise and lengthwise position.

### SUMMARY OF THE INVENTION

An aspect of exemplary embodiments of the present invention is to address at least the above problems and/or disadvantages and to provide at least the advantages described below. Accordingly, an aspect of the present invention is to provide a method of turning the data presented in a rotation allowable zone of the screen of the display to match the rotational position of the folder in a wireless terminal.

It is another object of the present invention to provide a method of turning both the data presented in a rotation allowable zone of the screen of the display and the data in a pop-up window in the rotation allowable zone to match the rotational position of the folder in a wireless terminal.

It is still another object of the present invention to provide a method of rearranging particular keys provided in the folder to match the rotational position of the folder.

According to an aspect of exemplary embodiments of the present invention, a method of presenting characters or images on the screen of the display is provided in the folder pivotally mounted on the main body of a wireless terminal, in which an existence of a rotation allowable zone is detected on the screen of the display upon turning the folder, and the data presented in the rotation allowable zone is turned to match the rotational direction of the folder, if the rotation allowable zone exists.

According to another aspect of exemplary embodiments of the present invention, a method of presenting characters or images on the screen of the display is provided in the folder pivotally mounted on the main body of a wireless terminal, in which an existence of a rotation allowable zone is detected on the screen of the display upon turning the folder, an existence of a pop-up window in the rotation allowable zone is detected, if the rotation allowable zone exists, and the data presented in the rotation allowable zone and the data in the pop-up window are turned to match the rotational direction of the folder, if the pop-up window exists.

According to still another aspect of exemplary embodiments of the present invention, a method of presenting characters or images on the screen of the display is provided in the folder pivotally mounted on the main body of a wireless terminal, in which an existence of a rotation allowable zone is detected on the screen of the display upon turning the folder, an existence of particular keys provided in the folder is detected, if the rotation allowable zone exists, and the data presented in the rotation allowable zone is turned, as well as functions of the particular keys are rearranged, to match the rotational direction of the folder, if the particular keys exist.

According to a further aspect of exemplary embodiments of the present invention, a method of presenting characters or images on the screen of the display is provided in the folder pivotally mounted on the main body of a wireless terminal, in which an existence of a rotation allowable zone is detected on the screen of the display upon turning the folder, an existence of a pop-up window is detected in the rotation allowable zone, if the rotation allowable zone exists, an existence of particular keys provided in the folder is detected, if the pop-up window exists in the rotation allowable zone, and the data presented in the rotation allowable zone and the data in the pop-up window are turned, as well as functions of the particular keys are rearranged, to match the rotational direction of the folder, if the particular keys exist.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE ATTACHED DRAWINGS

The above and other objects, features, and advantages of certain exemplary embodiments of the present invention will be more apparent from the following description taken in conjunction with the accompanying drawings, in which:

FIG. 1 is a block diagram for illustrating the functional structure of a wireless terminal employing a method according to an exemplary embodiment of the present invention;

FIG. 2 is a flow chart for illustrating the steps of the inventive method of presenting characters or images on the screen of the display provided in the folder of a wireless terminal to match the rotational position of the folder; and

FIGS. 3 to 5 are schematic diagrams for explaining the steps of FIG. 2.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

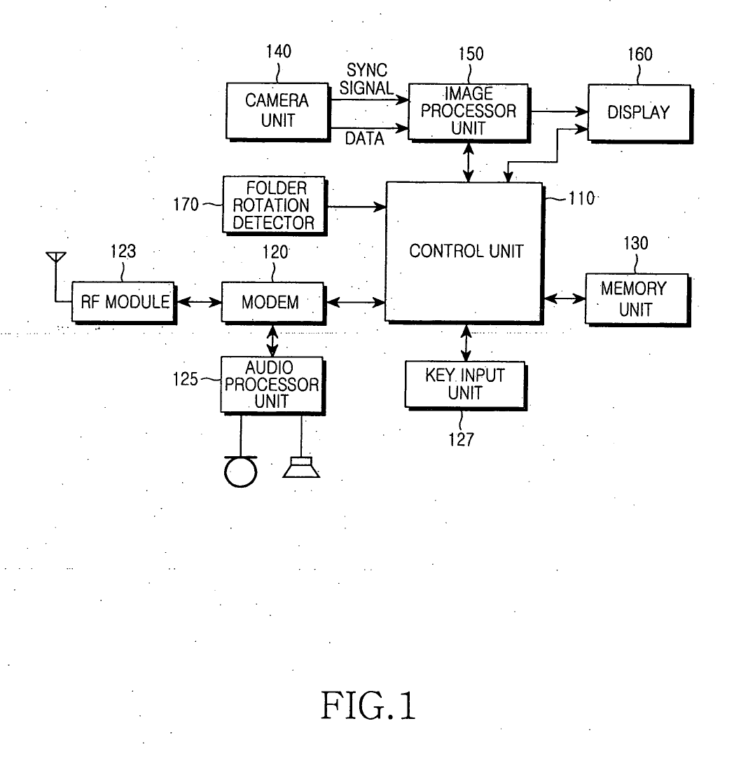

Referring to FIG. 1, an RF unit 123 for wireless communication comprises an RF transmitter for modulating and amplifying the frequency of a transmitted signal and an RF receiver for demodulating and low-noise amplifying a received signal. A modem 120 transforms digital signals from a control unit I 10 into corresponding analog signals delivered to the RF unit 123, or analog signals from the RF module into corresponding digital signals delivered to an audio processor unit 125 or the control unit 110. The audio processor unit 125 comprises a data codec for processing packet data and an audio codec for processing audio signals such as voice signals. The audio processor unit 125 converts the digital audio signals from the modem 120 into corresponding analog signals delivered to a speaker, or the analog audio signals from a microphone into corresponding digital signals delivered to the modem 120. The audio processor unit may be a separate unit or a built-in element of the control unit 110.

In an exemplary implementation, the rotational positions of the folder of the wireless terminal are defined in reference to the main body as follows. Namely, the position at which the folder is disposed parallel with the main body is defined as a first lengthwise position, and the position at which the folder is disposed crosswise to the main body as a second crosswise position.

A memory unit 130 comprises a program memory and a data memory. The program memory stores programs for controlling general operations of the wireless terminal including the programs for controlling the display to turn both data presented in a rotation allowable zone on the screen of the display and data in a pop-up window appearing in the rotation allowable zone, as well as rearranging functions of particular keys provided in the folder to match the second crosswise position of the folder. Meanwhile, the data memory serves to temporarily store data generated during execution of the programs.

The control unit 110 controls entire functions of the wireless terminal, and may be designed to include the modem 120 and the audio processor unit 125. Receiving a position detection signal from a folder rotation detector 170, the control unit 110 controls a display 160 to turn the data presented on the rotation allowable zone to match the rotational position of the folder.

According to an exemplary embodiment of the present invention, the control unit 110 controls the display to turn both the data presented in the rotation allowable zone and the data in a pop-up window appearing in the rotation allowable zone to match the rotational position of the folder according to a position detection signal generated by the folder rotation detector 170.

According to an exemplary embodiment of the present invention, the control unit 110 controls the display to turn the data presented in the rotation allowable zone, and the particular keys provided in the folder to rearrange their functions, to match the rotational position of the folder according to a position detection signal generated by the folder rotation detector 170.

According to an exemplary embodiment of the present invention, the control unit 110 controls the display to turn both the data presented in the rotation allowable zone and the data in the pop-up window in the rotation allowable zone, and the particular keys provided in the folder to rearrange their functions, to match the rotational position of the folder according to a position detection signal generated by the folder rotation detector 170.

Also provided is a camera unit 140 which comprises a camera sensor for converting the optical signals of a captured image into corresponding electrical signals, and a signal processor for converting the analog electrical signals from the camera sensor into the corresponding digital data. The camera sensor may be a Charged Coupled Device (CCD) sensor, and the signal processor may be a Digital Signal Processor (DSP). The camera sensor and the signal processor may be integrally combined, or separately formed.

An image processor unit 150 processes the images from the camera unit 140 by frames to generate the frame video data fitting characteristics and size of a display 160. The image processor unit 150 includes a video codec to compress the frame video data or decompress the compressed frame video data according to a prescribed process. The video codec may be Joint Photographic Experts Group (JPEG), Moving Picture Experts Group 4 (MPEG4), Wavelet, and the like. The image processor unit 150 is provided with an On Screen Display (OSD) function to generate the OSD data according to the screen size under the control of the control unit 110.

The display 160 displays both the images from the image processor unit 150 and the user's data transferred from the control unit 110. The display 160 may comprise an LCD device, LCD controller, and memory for storing the video data. The LCD device may be formed with the touch screen mode to serve as an input device.

The screen of the display 160 is divided into a first, second, and third display zone. The first display zone shows icon display data representing battery state, antenna receiving rate, vibration mode, and the like, the second display zone shows the video data together with the user's data, and the third display zone shows soft key display data.

The screen of the display 160 may be also divided into a rotation allowable zone and rotation unallowable zones. The rotation allowable zone is designed to have a rectangular or circular form so that the rotation allowable zone shape and size may not vary with its rotation. The rotation unallowable zones are designed to show data that hardly impair the readability even when being turned. Accordingly, the rotation allowable zone is provided by the second display zone, and the rotation unallowable zones are provided by the first and second display zones.

A key input unit 127 includes the keys for inputting information on numbers and characters, and the keys for setting various functions. The key input unit 127 may include particular keys provided in the folder together with the keys provided in the main body.

The folder rotation detector 170 detects the rotational position of the folder to generate a rotational position detection signal delivered to the control unit 110. According to an exemplary embodiment of the present invention, the folder rotation detector 170 generates a first or second rotational position detection signal according to the folder being in the first lengthwise or the second crosswise position. Alternatively, the position at which the folder is disposed crosswise to the main body by being turned left may be defined as the second crosswise position, and the position crosswise attained by being turned right may be defined as the third crosswise position. The third crosswise position may be represented by a third rotational position detection signal. However, the folder may be turned to the second crosswise position.

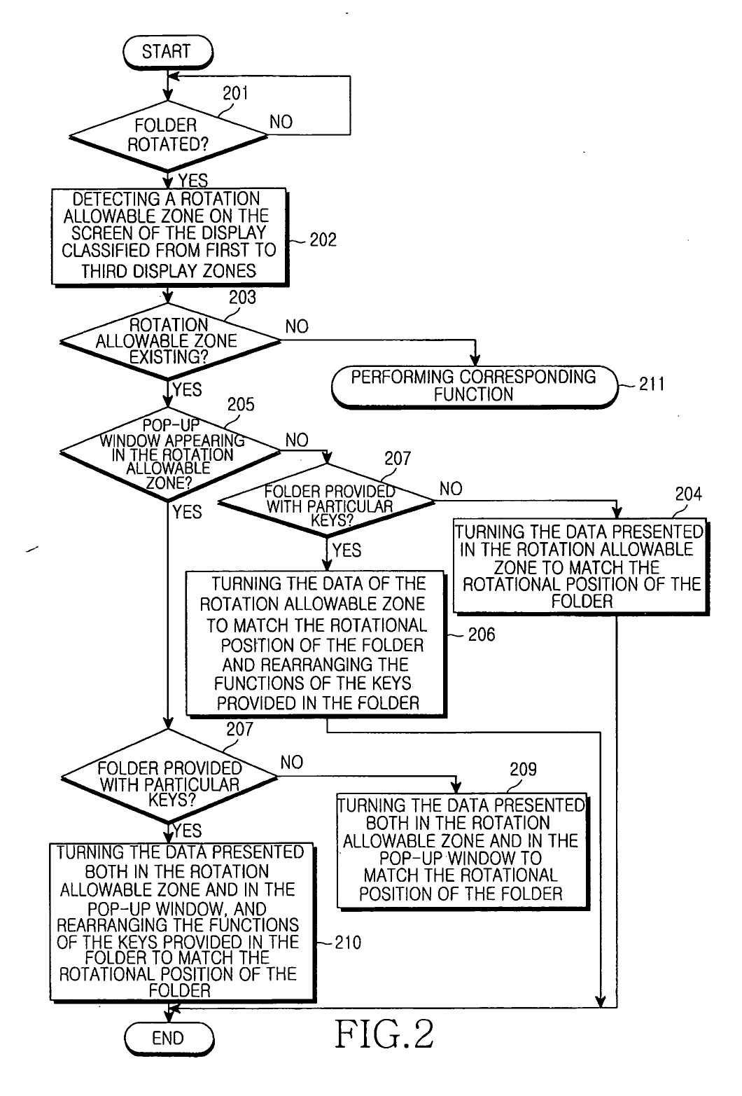

In an exemplary implementation, the inventive process for controlling the display to turn data in the rotation allowable zone and the particular keys provided in the folder to rearrange their functions to match the rotational position of the folder, in connection with FIGS. 2 to 5.

Referring to FIG. 2, when the folder of the wireless terminal is turned from the first lengthwise position to the second crosswise position, the folder rotation detector 170 detects the position in step 201 to generate a second position detection signal delivered to the control unit 110 to detect in step 202 a rotation allowable zone on the screen of the display 160 consisting of the first to third display zones. If the rotation allowable zone exists, the control unit 110 controls in step 203 the display 160 to turn right data presented in the second display zone of the rotation allowable zone to match the second crosswise position of the folder in step 204.

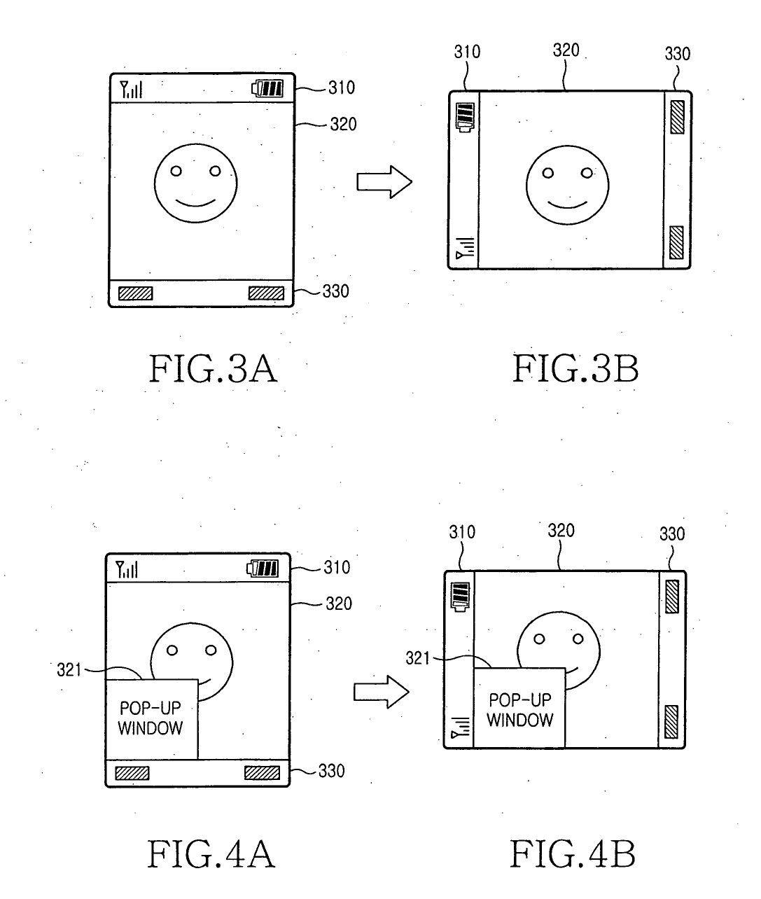

FIG. 3A shows the folder of the wireless terminal disposed in the first lengthwise position. Accordingly, the display 160 provided in the folder has the screen divided into the first, second, and third display zones 310, 320, and 330, respectively. In this instance, the folder rotation detector 170 generates the first position detection signal.

When the folder is turned left from the first lengthwise position as shown in FIG. 3A, the folder rotation detector 170 generates the second position detection signal delivered to the control unit 110 to turn data presented in the second display zone 320 to match the second crosswise position of the folder as shown in FIG. 3B.

After the rotation allowable zone has been detected in the display 160 in step 203, the control unit 110 determines in step 207 whether the folder is provided with particular keys. Detecting the particular keys, the control unit 110 controls in step 206 the display to turn right data presented in the second display zone and the particular keys to rearrange their functions to match the second crosswise position of the folder. For example, if the particular keys provided in the folder are directional keys indicating respectively up, down, left, and right directions in the first lengthwise position of the folder, the keys direction indicating functions are rearranged in step 206 so that the initially up key may provide the function of the initially left key, the initially down key provides the function of the initially right key, the initially left key provides the function of the initially down key, and the initially right key provides the function of the initially up key in the second crosswise position of the folder.

Additionally after the rotation allowable zone has been detected in the display 160 in step 203, the control unit 110 determines in step 205 whether a pop-up window appears in the rotation allowable zone. If the pop-up window appears, the control unit 110 controls the display 160 to turn right data presented both in the rotation allowable zone and in the pop-up window to match the second crosswise position of the folder in step 209.

FIG. 4A shows the folder of the wireless terminal disposed in the first lengthwise position, wherein the display 160 provided in the folder has the screen divided into the first, second, and third display zones 310, 320, and 330. The pop-up window 321 appears in the second display zone 320. In this instance, the folder rotation detector 170 generates the first position detection signal.

When the folder is turned left from the first lengthwise position as shown in FIG. 4A, the folder rotation detector 170 generates the second position detection signal delivered to the control unit 110 to turn the data presented both in the second display zone 320 and in the pop-up window 321 to match the second crosswise position of the folder as shown in FIG. 4B.

For example, after detecting the rotation allowable zone in the display in step 203, the control unit 110 determines in step 205 whether the pop-up window appears in the rotation allowable zone. Then in step 208, the control unit 110 determines whether the folder is provided with the particular keys. Subsequently, the control unit 110 controls in step 210 the display to turn data presented both in the rotation allowable zone and in the pop-up window, and the particular keys provided in the folder to rearrange their functions.

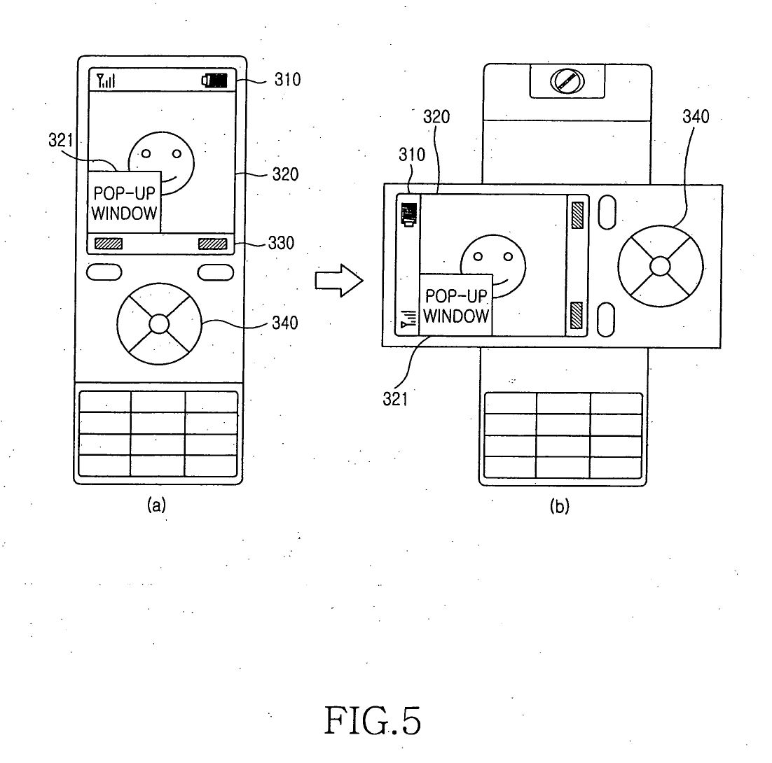

FIG. 5A shows the folder of the wireless terminal disposed in the first lengthwise position, wherein the display 160 provided in the folder has the screen divided into the first, second, and third display zones 310, 320, and 330. The pop-up window 321 appears in the second display zone 320. The folder is also provided with the particular keys 340 serving as the directional keys. In this case, the folder rotation detector 170 generates the first position detection signal.

When the folder is turned left from the first lengthwise position as shown in FIG. 5A, the folder rotation detector 170 generates the second position detection signal delivered to the control unit 110 to turn data presented both in the second display zone 320 and in the pop-up window 321 to match the second crosswise position of the folder as shown in FIG. 5B. In addition, the control unit 110 controls the directional keys 340 to rearrange their functions so that the initially up key may provide the function of the initially left key, the initially down key provides the function of the initially right key, the initially left key provides the function of the initially down key, and the initially right key provides the function of the initially up key in the second crosswise position of the folder.

In the exemplary embodiments of the invention, a method of controlling a display to turn data presented both in a rotation allowable zone and in a pop-up window, and particular keys provided in a folder to rearrange their functions, especially when the folder is turned left to the second crosswise position has been described. However, similar steps may be applied to achieve the objects of the present invention when the folder is returned to the first lengthwise position or turned right to the third crosswise position.

Thus, the exemplary embodiments of present invention provide the wireless terminal with a method of turning data presented in the rotation allowable zone of the display, thereby significantly reducing the size of software and consumption of memory resources.

While the present invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of presenting images on the screen of a display provided in a wireless terminal, the method comprising:
detecting an existence of a rotation allowable zone on the screen of the display upon turning the folder; and
turning data presented in the rotation allowable zone to match the rotational direction of the folder, if the rotation allowable zone exists.

2. The method as defined in claim 1, wherein the rotation allowable zone shape and size remains with the turning of the folder.

3. The method as defined in claim 1, wherein the screen of the display comprises rotation allowable and unallowable zones.

4. The method as defined in claim 3, wherein the screen is divided into a first display zone presenting icon display data, a second display zone presenting the characters or images, and a third display zone presenting soft key display data, the first and third display zones comprising the rotation unallowable zones, and the second display zone comprising the rotation allowable zone.

5. The method as defined in claim 1, wherein the folder is disposed crosswise to the main body of the wireless terminal.

6. A method of presenting images on the screen of a display provided in a wireless terminal, the method comprising:
detecting an existence of a rotation allowable zone on the screen of the display upon turning the folder;
detecting an existence of a pop-up window in the rotation allowable zone, if the rotation allowable zone exists; and
turning data presented in the rotation allowable zone and in the pop-up window to match the rotational direction of the folder, if the pop-up window exists.

7. The method as defined in claim 6, further comprising turning the data presented in the rotation allowable zone to match the rotational direction of the folder, if the pop-up window does not exist in the rotation allowable zone.

8. The method as defined in claim 6, wherein the rotation allowable zone size and shape remains with the turning of the folder.

9. The method as defined in claim 6, wherein the screen of the display comprises rotation allowable and unallowable zones.

10. The method as defined in claim 9, wherein the screen is divided into a first display zone presenting icon display data, a second display zone presenting the characters or images, and a third display zone presenting soft key display data, the first and third display zones comprising the rotation unallowable zones, and the second display zone comprising the rotation allowable zone.

11. The method as defined in claim 6, wherein the folder is disposed crosswise to the main body of the wireless terminal.

12. A method of presenting images on the screen of a display provided in a wireless terminal, the method comprising:
detecting an existence of a rotation allowable zone on the screen of the display upon turning the folder;
detecting an existence of particular keys provided in the folder, if the rotation allowable zone exists; and
turning the data presented in the rotation allowable zone as well as rearranging the functions of the particular keys to match the rotational direction of the folder, if the particular keys exist.

13. The method as defined in claim 12, further comprising turning the data presented in the rotation allowable zone to match the rotational direction of the folder, if the particular keys does not exist.

14. The method as defined in claim 12, wherein the rotation allowable zone size and shape remains with the turning of the folder.

15. The method as defined in claim 12, wherein the screen of the display comprises rotation allowable and unallowable zones.

16. The method as defined in claim 15, wherein the screen is divided into a first display zone presenting icon display data, a second display zone presenting the characters or images, and a third display zone presenting soft key display data, the first and third display zones comprising the rotation unallowable zones, and the second display zone comprising the rotation allowable zone.

17. The method as defined in claim 12, wherein the folder is disposed crosswise to the main body of the wireless terminal.

18. A method of presenting images on the screen of a display provided in a wireless terminal, the method comprising:
detecting an existence of a rotation allowable zone on the screen of the display upon turning the folder;
detecting an existence of a pop-up window in the rotation allowable zone, if the rotation allowable zone exists;
detecting an existence of particular keys provided in the folder, if the pop-up window exists in the rotation allowable zone; and
turning the data presented in the rotation allowable zone and the data in the pop-up window, and rearranging the functions of the particular keys to match the rotational direction of the folder, if the particular keys exist.

19. The method as defined in claim 18, comprising detecting an existence of particular keys provided in the folder, if a pop-up window does not exist in the rotation allowable zone; and
turning data presented in the rotation allowable zone and rearranging the functions of the particular keys to match the rotational direction of the folder, if the particular keys exist.

20. The method as defined in claim 19, comprising turning the data presented in the rotation allowable zone to match the rotational direction of the folder, if the particular keys does not exist.

21. The method as defined in claim 18, comprising turning the data presented in the rotation allowable zone and the data in the pop-up window to match rotational direction of the folder, if the particular keys does not exist.

22. The method as defined in claim 18, wherein the rotation allowable zone size and shape remains with the turning of the folder.

23. The method as defined in claim 18, wherein the screen of the display comprises rotation allowable and unallowable zones.

24. The method as defined in claim 23, wherein the screen is divided into a first display zone presenting icon display data, a second display zone presenting the characters or images, and a third display zone presenting soft key display data, the first and third display zones comprising the rotation unallowable zones, and the second display zone comprising the rotation allowable zone.

25. The method as defined in claim 18, wherein the folder is disposed crosswise to the main body of the wireless terminal.

26. A wireless terminal comprising:
a main body;
a folder pivotally mounted on the main body to be turned to at least one of a first lengthwise position at which the folder is disposed parallel with the main body and a second crosswise position at which the folder is disposed crosswise to the main body;
a display mounted on the folder; and
a control unit for presenting characters or images on the screen of the display by detecting an existence of a rotation allowable zone on the screen of the display upon turning the folder, an existence of a pop-up window in the rotation allowable zone, if the rotation allowable zone exists, an existence of particular keys provided in the folder, if the pop-up window exists in the rotation allowable zone, and turning the data presented in the rotation allowable zone and the data in the pop-up window, and rearranging the functions of the particular keys to match the rotational direction of the folder, if the particular keys exists.
